(19) United States
(12) Patent Application Publication
(10) Pub. No.: US 2002/0150375 A1
(43) Pub. Date: Oct. 17, 2002

(54) Crimp for providing hermetic seal for optical fiber

(76) Inventors: Henry H. Hung, Phoenix, AZ (US); Christopher A. Lopez, Phoenix, AZ (US); Majid Malakia, Scottsdale, AZ (US)

Correspondence Address: Tod R. Nissle, Esq., TOD R. NISSLE, P.C., P. O. Box 55630, Phoenix, AZ, 85078, US

(21) Appl. No.: 09/835,219

(22) Filed: Apr. 13, 2001

(51) Int. Cl. G02B 6/36

(52) U.S. Cl. 385/138

(57) ABSTRACT

A method and apparatus for sealing an optical fiber in the wall of a modulator housing utilizes a metal crimp to compress sealingly a elastomer sleeve against the optical fiber.

This invention relates to the packaging of an optic circuit.

More particularly the invention relates to the installation of an optical fiber during packaging of an optic circuit.

An integrated optic chip (IOC) is made of an electro-optic material whose index of refraction increases or decreases depending on the direction of electric field applied to it. IOC's are analogous to integrated circuits (IC's) utilized in semiconductor technology. The signal processing in an IC is totally electric whereas in an IOC it is both optical and electrical. The term “integrated” in “integrated optic chip” implies that the chip has both electrical and optical parts. One or more external electrical signal(s) is applied to one or more electrodes formed on an IOC and the electrical signals change the index of refraction of one or more waveguides adjacent to the electrodes. Changing the index of refraction of a waveguide produces a concomitant change in the intensity and/or phase of light passing through the waveguide. An IOC device is a device which includes one or more IOCs.

An integrated optic device (IOD) is one of a class of devices for guiding and controlling light in thin film layers or in narrow waveguide channels formed in a suitable material, which suitable material normally comprises a dielectric. The IOD can comprise either a single type including transducers, filters, modulators, memory elements, and others or of several function applications (IOCs) combined (“integrated”) into a single device.

An optic circuit is a circuit which includes one or more IOCs, one or more IODs, or which transmits light through a solid material that comprises part of the circuit.

During the installation of a modulator or other optic circuit in a protective housing, an optical fiber is directed through an aperture in the wall of the housing and is connected to the modulator. One problem encountered in installing an optical fiber involves passage of the fiber through an aperture in the wall of the protective housing. A hollow feedthrough tube is soldered in the aperture. A center portion of the fiber is gold plated and soldered inside a stainless steel protective sleeve. The fiber is then passed through the aperture such that the stainless steel protective sleeve is positioned in the hollow feedthrough tube. One end of the fiber is pigtailed or otherwise connected to the modulator. The protective sleeve is then soldered to the feedthrough tube. Coating the fiber with gold and soldering the fiber into the stainless steel protective sleeve makes the fiber fragile and susceptible to breaking at the solder joint. This method is also labor intensive and costly.

Accordingly, it would be highly desirable to provide an improved optic circuit packaging method and apparatus which would reduce the risk of breakage of an optical fiber soldered in place during packaging of an optic circuit, and which would simplify the process of forming a hermetic seal during installation of the optical fiber.

Therefore, it is a principal object of the invention to provide an improved method and apparatus for packaging an optic circuit.

Another object of the invention is to provide an improved method and apparatus for hermetically sealing on optical fiber in the wall of a housing for a modulator or other optic circuit.

These and other, further and more specific objects and advantages of the invention will be apparent to those of skill in the art from the following detailed description thereof, taken in conjunction with the drawings, in which:

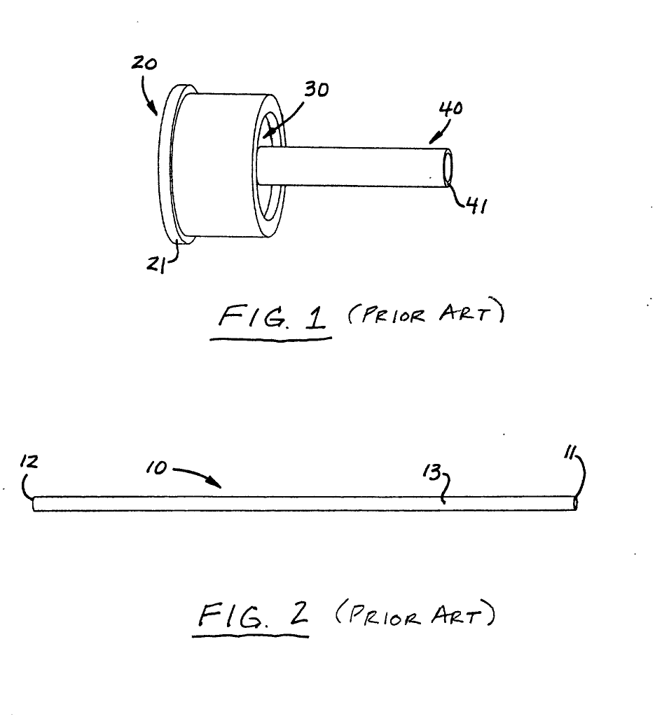

FIG. 1 is a perspective view illustrating a component utilized to form a hermetic seal in accordance with the prior art;

FIG. 2 is a perspective view illustrating another component utilized to form a hermetic seal in accordance with the prior art;

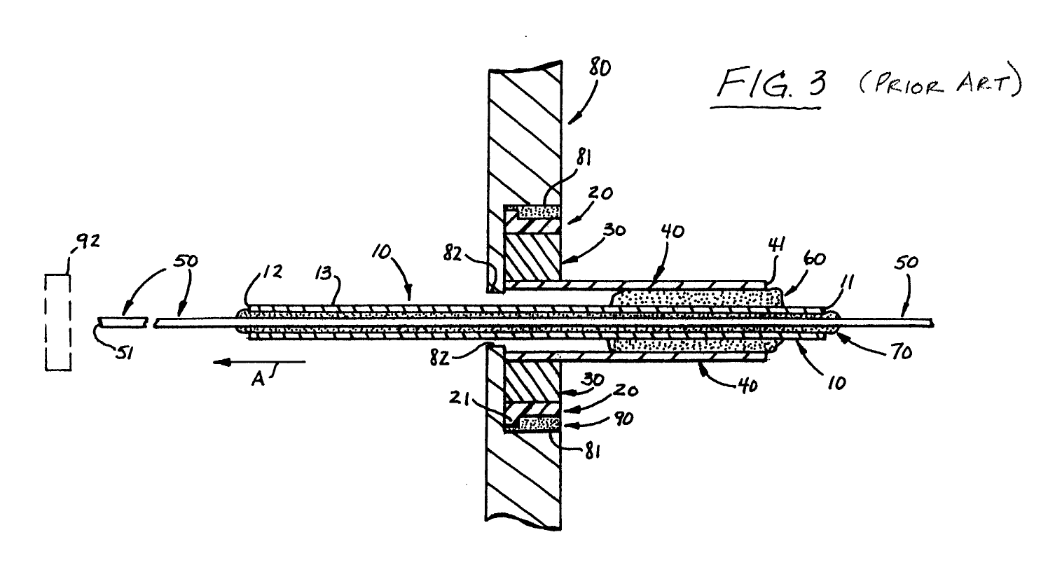

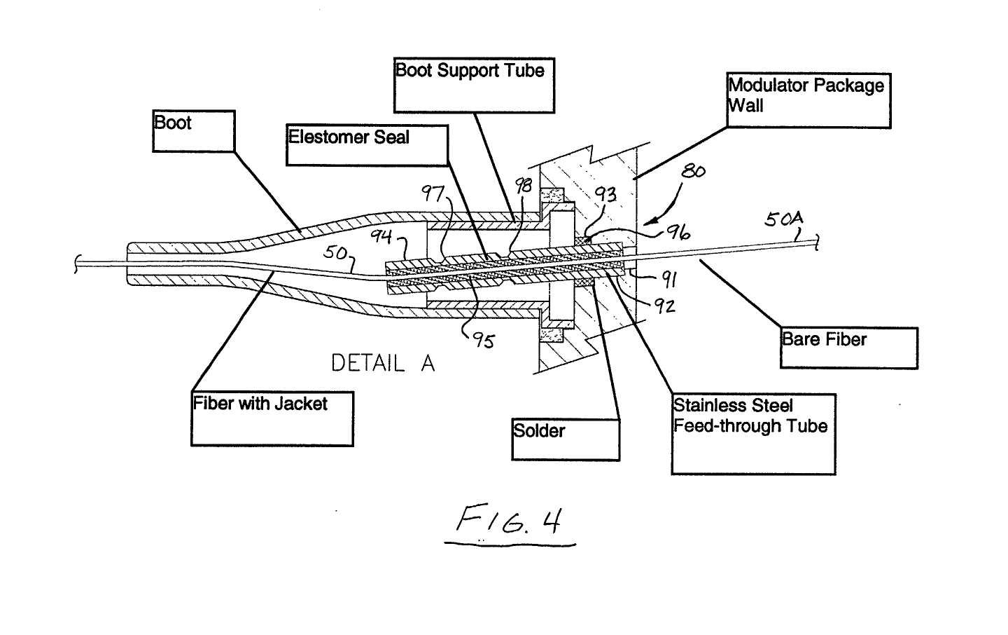

FIG. 3 is a side section view illustrating a hermetic seal formed in a housing for an optical circuit in accordance with the prior art; and,

FIG. 4 is a side section view illustrating a hermetic seal formed in a housing for an optic circuit in accordance with the invention.

Briefly, in accordance with the invention, I provide an improved method for installing an optical fiber in an aperture formed through the wall of a housing for an optic circuit, comprising the step of mounting a portion of the optical fiber in a mounting member. The mounting member includes a crimpable hollow tube, and a hollow elastomer sleeve inside the tube. The portion of the optical fiber extends through the elastomer sleeve. The method also includes the steps of crimping the tube to compress at least a portion of the sleeve against the portion of the optical fiber; and, installing the mounting member in the aperture.

In another embodiment of the invention, I provide improvements in combination with an optical fiber mounted in an aperture formed through the wall of a housing for an optic circuit. The improvements reduce the cost of installing the optical fiber and include a hollow crimpable tube and a hollow elastomer sleeve inside the tube. The fiber extends through the elastomer sleeve.

Turning now to the drawings, which depict the presently preferred embodiments of the invention for the purpose of illustrating the practice thereof and not by way of limitation of the scope of the invention, and in which like reference characters refer to corresponding elements throughout the several views, FIGS. 1 to 3 illustrate prior art apparatus for installing an optical fiber in the wall of a housing for an optic circuit.

FIG. 1 illustrates a hollow cylindrical metal component 20, hollow metal component 40, and a cylindrical insulative glass seal 30 extending between and separating components 20 and 40. Seal 30 functions as an insulator and prevents or slows the transfer of heat from component 40 to component 20. The spanning of seal 30 intermediate components 20 and 40 is also depicted in FIG. 3. Component 20 includes outwardly depending circular lip 21. Component 40 includes end 41.

FIG. 2 illustrates hollow cylindrical metal stainless steel component 10. The outer cylindrical surface 13 and inner cylindrical surface of component 10 are presently preferably covered by a gold coating. Component 10 includes ends 11 and 12. The shape and dimension of and materials used to construct components 10 and 20 and the other components discussed below can vary as desired.

FIG. 3 illustrates a structural component comprising a wall 80. Wall 80 forms one side of the housing of an IOC or other optic circuit. During the following explanation of the assembly of the hermetic seal depicted in FIG. 3, it is assumed that the IOC housing comprises a hollow rectangular container, the top or lid of which has been removed. As would be appreciated by those of skill in the art, however, the shape and dimension of the IOC housing can vary as desired.

At least one IOC is in the hollow rectangular container. Optical fiber 50 must be connected to the IOC and must be hermetically sealed in wall 80. At some time subsequent to the connection of fiber 50 to the IOC and subsequent to the hermetic sealing of fiber 50 in wall 80, the lid of the housing is sealingly affixed to the hollow rectangular container to complete the hermetic sealing of the IOC in the box.

In order to produce the hermetic seal assembly illustrated in FIG. 3, cylindrical openings 81 and 82 are formed in wall 80. An end of component 40 is centered or otherwise positioned inside hollow cylindrical component 20, and insulative glass seal 30 is formed to fix the end of component 40 inside component 20 in the manner illustrated in FIG. 1. Component 20 is then seated in cylindrical opening 81 in the position shown in FIG. 3 and indium solder 90 is heated to 250 degrees C. and inserted intermediate opening 81 and the outer cylindrical surface of member 20 in the manner illustrated in FIG. 3. Solder 90 is permitted to harden.

Metallized optical fiber 50 (for example, an optic fiber coated with the metal gold) is slid through component 10 to the position illustrated in FIG. 3 and indium solder 70 is heated to 250 degrees C. and applied near ends 11 and 12 of component 10. Surface tension and capillary action cause the liquid solder 70 to wick or travel into component 10 intermediate fiber 50 and the inner cylindrical gold-plated surface of component 10. This wicking action may not completely fill the space between fiber 50 and the inside of component 10 in the manner shown in FIG. 3, but at least some of the solder 70 does wick inside component 10. The solder 70 is allowed to cool and harden to affix fiber 50 inside component 10.

After the solder 70 has cooled, component 10 (along with fiber 50 and solder 70 extending through component 10) is inserted through component 40 to the approximate position illustrated in FIG. 3. While any means or apparatus can be utilized to accomplish the positioning of component 10 in component 40, a vacuum chuck can be utilized to grasp and hold the end of fiber 50 extending out the right hand end (or left hand end) of component 10 in FIG. 3. The position of the vacuum chuck is adjustable up or down, left or right, front and back, etc. so that the position of fiber 50 and component 10 inside member 40 can be adjusted. This is important because when fiber 50 is in the position illustrated in FIG. 3 and is extending through member 40 and opening 82, the position of fiber 50 (and component 10) must be adjustable so that fiber 50 can be positioned with the vacuum chuck accurately to be connected to the IOC 92 which is inside the IOC housing of which wall 80 comprises a side. Once fiber 50 has been adjusted to its desired position and end 51 of fiber 50 has been connected to the IOC 92 which is inside the IOC housing, then indium solder 60 is heated to about 120 degrees C. and is deposited at end 41 of component 40. Some of the solder 60 wicks inside component 40 in the manner illustrated in FIG. 3. If desired, solder 60 can also be deposited in opening 82 to further secure component 10 in wall 80. After solder 60 cools and solidifies, a hermetic seal has been formed between fiber 50 and opening 81.

Any desired solder can be utilized in the practice of the invention. To insure that the solder 60, 70, 90 forms a good hermetic seal, it is presently preferred that a metal solder be utilized.

FIG. 4 illustrates an optic circuit packaged in accordance with the invention. Optical fiber assembly 50A is slid through cylindrical stainless steel feed-through tube 92. Fiber assembly 50A need not be coated with gold. Fiber assembly 50A does, however, include an optical fiber and a polymer jacket which protects and supports the optical fiber. Hollow cylindrical elastomer seal 95 is slid over fiber assembly 50A, seal 95, and assembly 50A are pressed into tube 92 to the position shown in FIG. 4. Seal 95 is normally installed at room temperature, although this temperature can vary as desired. Seal 95 is preferably, but not necessarily, bendable and impermeable to (or at least resistant to absorbing) water, chemicals, and/or gases. Seal 95 is preferably, but not necessarily, resistant to heat and cold in the range of zero degrees C. up to 50 degrees C., preferably −40 degrees C. up to 85 degrees C. Seal 95 preferably, but not necessarily, can be bent readily to reduce the risk that the optical fiber in assembly 50A will be damaged. Seal 95 is preferably shaped and dimensioned to closely fit assembly 50A, while at the same time permitting seal 95 to be slid over assembly 50A without undue effort.

After seal 95 is inserted in tube 92, tube 92 is compressed at selected points to form crimps 97 and 98. Each crimp 97, 98 at least partially circumscribes tube 92. Each crimp 97, 98 preferably completely circumscribes tube 92. Each crimp 97, 98 compresses a portion of seal 95 against fiber assembly 50A to hermetically seal fiber assembly 50A inside tube 92. One end of tube 92 is seated in cylindrical aperture 92 formed in wall 80. Solder 96 in cylindrical aperture 93 secures tube 92 in aperture 92. While only one crimp 97, 98 may be sufficient, it is preferred to use two to four crimps. The crimped portion of tube 92 preferably does not contact fiber assembly 50A. A portion of seal 95 should be between the assembly 50A and the crimped portion of tube 92.

If desired, seal 95 can first be installed in stainless steel tube 92, fiber assembly 50 can be slid through seal 95, and tube 92 crimped. Tube 92 ordinarily is soldered in position before fiber assembly 50 and elastomer sleeve 95 are installed in tube 92.

Tube 92 is presently preferably made from a metal to facilitate soldering tube 92 in position in the wall of the modulator wall 80.

Having described my invention in such terms as to enable those of skill in the art to make and practice it, and having described the presently preferred embodiments thereof,

I Claim:

1. A method for installing an optical fiber in an aperture formed through the wall of a housing for an optic circuit, comprising the steps of
(a) mounting a portion of the optical fiber in a mounting member, said mounting member including
(i) a crimpable hollow tube, and
(ii) a hollow elastomer sleeve inside said tube, said portion of the optical fiber extending through said elastomer sleeve;
(b) crimping said tube to compress at least a portion of said sleeve against said portion of the optical fiber; and,
(c) installing the mounting member in the aperture;

2. In combination with an optical fiber mounted in an aperture formed through the wall of a housing for an optic circuit, the improvements for reducing the breakage of the optical fiber, said improvement including a hollow crimpable tube and a hollow elastomer sleeve inside said tube, said fiber extending through said elastomer sleeve.
